(19) United States
(12) Patent Application Publication
(10) Pub. No.: US 2026/0194723 A1
(43) Pub. Date: Jul. 9, 2026

(54) FIBER ARRAY UNIT WITH ALIGNMENT FIBER

(71) Applicant: Mellanox Technologies, Ltd., Yokneam (IL)

(72) Inventors: Amir Silber, Rehovot (IL); Nizan Meitav, Kiryat Ata (IL)

(21) Appl. No.: 19/199,950

(22) Filed: May 6, 2025

Related U.S. Application Data
(60) Provisional application No. 63/742,832, filed on Jan. 7, 2025.

(51) Int. Cl. G02B 6/42

(52) U.S. Cl. CPC G02B 6/4225; G02B 6/4286

(57) ABSTRACT

A fiber array unit (FAU) including a first set of fibers disposed in a substrate, the first set of fibers to transmit a first portion of an emitted light from a light source to a destination component. The FAU further includes a second set of one or more fibers disposed in the substrate and arranged in a parallel orientation relative to the first set of one or more fibers, the second set of one or more fibers to transmit a second portion of the emitted light from the light source to the destination component and transmit at least a portion of returned light received from a deflective surface of the destination component. The FAU further includes a refractive component disposed in optical communication with the second set of one or more fibers, wherein the refractive component folds the second portion of the emitted light in a perpendicular orientation relative to the deflective surface of the destination component.

### CROSS-REFERENCE TO RELATED APPLICATION

This application claims the benefit of U.S. Provisional Application No. 63/742,832, titled “Fiber Array Unit with Inside Optical Channel for Distance and Angle Sensing,” filed Jan. 7, 2025, the entire disclosure of which is incorporated herein by reference.

### TECHNICAL FIELD

At least one embodiment pertains to systems and techniques deployed to facilitate optical communications.

### BACKGROUND

Optical communication systems transmit data using light waves. Many such optical systems include a fiber array unit which provides multiple optical fibers configured to couple light from a light source (e.g., a laser) and transmit the light beam to a destination component (e.g., a wafer, a waveguide component of a photonic integrated circuit (PIC), etc.). The fiber array unit (FAU) may be used to align and interface optical fibers with other optical components to enable the delivery of the light transmission to the destination component. A typical FAU consists of multiple optical fibers arranged in a fixed configuration, ensuring efficient coupling with optical devices such as photonic integrated circuits (PICs) or wafers. This alignment is vital for minimizing optical losses and maintaining the polarization of light. Fiber array units are widely used in telecommunications, data centers, and high-performance computing, enabling seamless optical connectivity between different modules and systems.

The wafer component in optical communication systems typically refers to a substrate on which photonic integrated circuits, optoelectronic devices, or optical devices or circuits are fabricated. These wafers, often made of materials such as silicon, indium phosphide, or gallium arsenide, serve as the foundational layer for Silicon Photonics and advanced optical components, including lasers, modulators, and photodetectors. The integration of optical fibers with wafers enables compact and high-performance optical communication modules, facilitating efficient data transfer with minimal latency. This combination of fiber arrays and wafers is essential in modern optical networks, where miniaturization, speed, and reliability are key drivers of technological advancement.

In some systems, the FAU may be placed in front of a deflective surface of the destination component such that the light beam emitted by the FAU is non-perpendicular to a flat surface of the component. In such instances, if not precisely aligned, a portion of the light beam emitted by the FAU reflects or deflects off of the deflective surface of the destination component, resulting in loss of transmission or optical mode deformation. Accordingly, there is a need to align the FAU with the flat deflective surface of the component for optimal light transmission.

### BRIEF DESCRIPTION OF DRAWINGS

Various embodiments in accordance with the present disclosure will be described with reference to the drawings, in which:

FIG. 1A illustrates a top view of an example fiber array unit including one or more alignment fibers, in accordance with one or more embodiments.

FIG. 1B illustrates a front view of an example fiber array unit and a destination component, in accordance with one or more embodiments.

FIG. 2 illustrates an example system including a control system to adjust one or more parameters associated with an alignment of a fiber array unit and destination component, in accordance with one or more embodiments.

FIG. 3 is a flow diagram of an example method of adjusting an alignment of a fiber array unit and a destination component, in accordance with one or more embodiments.

FIG. 4 illustrates an example graph depicting a coupling ratio associated with the optical transmission between a fiber array unit including one or more collimated alignment fibers and a destination component as a function of an example adjustable tilt angle, at various gap distances, in accordance with one or more embodiments.

FIG. 5 illustrates an example graph depicting a coupling ratio associated with the optical transmission between a fiber array unit including one or more non-collimated alignment fibers and a destination component as a function of an example adjustable tilt angle, at various gap distances, in accordance with one or more embodiments.

FIGS. 6A-6B illustrates a cross-sectional view and a top plan view, respectively, of an example destination component including one or more optoelectronic components, according to one or more embodiments.

FIG. 7 illustrates a portion of an example optoelectronic component, according to one or more embodiments.

FIG. 8 illustrates a portion of an example optoelectronic component, according to one or more embodiments.

FIG. 9 is a flow diagram of an example method of configuring and transmitting an optical signal via a fiber array unit, in accordance with one or more embodiments.

FIG. 10 is a flow diagram of an example method of receiving an optical signal transmitted via a fiber array unit and adjusting an alignment based on the received optical signal, in accordance with one or more embodiments.

FIG. 11 illustrates an example computing system, in accordance with one or more embodiments.

FIGS. 12A-12B illustrate a network architecture, in accordance with at least some embodiments.

FIG. 13 illustrates an example computing system, in accordance with at least some embodiments.

### DETAILED DESCRIPTION

As described above, systems and techniques to determine a desired alignment between a fiber array unit (FAU) and a destination component having a deflective surface may be needed. The problem involves aligning the fiber array unit to a flat and refractive surface, which is different from aligning fibers to fibers. The challenge is to ensure that the FAU height is set correctly and that the FAU is perfectly parallel to the surface. For example, the FAU may transmit light to a destination component that has a flat and refractive surface, which causes a portion of the light to be lost due to deflection off of the deflective surface of the destination component. Accordingly, there is a need to align the FAU and the destination component to reduce or eliminate the amount of deflected light.

In one example, the destination component includes processors which may include central processing units (CPUs), graphics processing units (GPUs), data processing units (DPUs), quantum processing units (QPUs), a plurality of parallel processing units (PPUs), and application-specific integrated circuits (ASICs). QPUs configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

Advantageously, aspects of the present disclosure are directed to an FAU including an array of multiple fibers (the “FAU fibers”) and an additional channel or fiber (the “alignment fiber”). The arranged combination of the FAU fibers and the alignment fiber (herein referred to as an “alignment FAU”) further includes a refractive component (e.g., a prism, a lens, etc.) disposed in optical communication with the alignment fiber such that the refractive component folds the light passing through the alignment fiber to be perpendicular to a deflective surface of a destination component (e.g., a wafer) to which the light emitted by the alignment FAU is directed. The alignment fiber may be single mode, multi-mode may include a multiple fibers. According to embodiments, the light passing through the alignment fiber and the refractive component is at or near perfect perpendicularity relative to the surface of the destination component (i.e., at or near 0° incident), such that the light deflected by the deflective surface and returned via the alignment fiber reaches a target or threshold level providing a feedback loop enabling an accurate and repeatable process for improved precision during the alignment process to align FAU angle, and FAU distance from the destination component (e.g., wafer) surface across multiple degrees of freedom (e.g., six degrees of freedom). According to embodiments, if the returned light reaches the target level, it can be determined that the alignment FAU is optimally aligned (e.g., perpendicular to the surface) and spaced relative to the destination component.

According to embodiments, the alignment fiber is employed to capture and transmit the returned light (i.e., the light deflected off of the deflective surface of the destination component) to enable the returned light to be measured and compared to a threshold (or target) level (e.g., a threshold power level associated with the returned light). According to embodiments, one or more adjustments to the alignment FAU and/or the destination component are made based on the result of the comparison of the measured light returned by the alignment fiber and the threshold level. In an embodiment, one or more adjustments may be made to a relative tilt angle (e.g., along one or more axes) and/or a distance between the alignment FAU and the destination component (i.e., a Zgap) based on the comparison of the measured returned light and the threshold level.

According to embodiments, for purposes of adjusting the alignment of the FAU and the destination component (e.g., in a wafer testing or packaging environment), a system is provided including an optical distribution component (e.g., a circulator, a splitter, or other suitable distribution component) used to collect the light returned via the alignment fiber of the alignment FAU and provide the returned light to an optical power meter. The optical power meter can measure a power level of the light returned from the deflective surface of the destination component via the dedicated channel (i.e., the alignment fiber). According to this embodiment, the light source, the alignment fiber, the optical distribution component, and optical power meter provide a dedicated channel for the purposes of measuring the returned light.

According to embodiments, the system includes processing logic (e.g., a controller) that compares the measured returned light and the threshold level and causes one or more adjustments to one or more relative tilt angle(s) associated with the alignment FAU and the destination component and/or a distance between the alignment FAU and the destination component.

According to embodiments, the controller uses the measured power level of the returned light to determine if the alignment FAU and the destination component are in a desired or target alignment (e.g., the measured power level of the returned light equals a threshold or target power level). In the event that the target alignment has not been established, the controller adjusts one or more parameters of the alignment FAU and/or the destination component, such as, for example, a distance between the alignment FAU and the destination component (i.e., the Zgap) and/or one or more tilt angles (e.g., tilt angle X corresponding to rotation relative to an X axis, title angle Y corresponding to rotation relative to a Y axis, and/or tilt angle Z corresponding to rotation relative to a Z axis) of the alignment FAU and/or destination component to cause the measured power level of the returned light to reach the target level. Once the target level is reached, it can be determined that FAU and destination component are optimally aligned with one another.

According to embodiments, if the controller determines that the measured returned light is less than the threshold level, the controller can adjust a tilt angle (e.g., tilt angle X, Y, or Z) of the alignment FAU relative to the destination component (or vice versa). The alignment adjustment process can include the adjusting (e.g., increasing or decreasing) of a first tilt angle (e.g., tilt angle X, Y, or Z) of a set of adjustable tilt angles by a step amount (e.g., 0.01 degrees). The alignment adjustment process iteratively adjusts and measures a new returned light level (i.e., the returned light level produced by the adjusted relative positioning of the alignment FAU and destination component), determines a new or updated comparison result, and, if necessary, causes a further adjustment of the respective tilt angles of the set of tilt angles. In an embodiment, if the controller determines that a last measured returned light level has not reached the threshold level and a range of adjustments of each adjustable tilt angle has been exhausted (e.g., the tilt angles have been fully adjusted), the controller can adjust a distance between the alignment FAU and the destination component (e.g., decrease the Zgap by a step distance amount). In an embodiment, the controller can iteratively adjust the Zgap and perform the measurement and comparison operations until a final measured returned light level is greater than or equal to the threshold level. According to embodiments, at the completion of the alignment adjustment process, the controller can identify an optimized alignment (e.g., set of tilt angles and Zgap involving six degrees of freedom) between the alignment FAU and the destination component, such that the returned light transmitted via the alignment fiber meets or exceeds the threshold level.

According to embodiments, the optimized alignment (e.g., an adjusted or final set of title angles and Zgap distance) may be established in a testing environment such that the adjusted or final set of tilt angles and Zgap distance may be used when installing a new FAU (e.g., establish repeatable tilt angles and Zgap distancing when installing a new FAU).

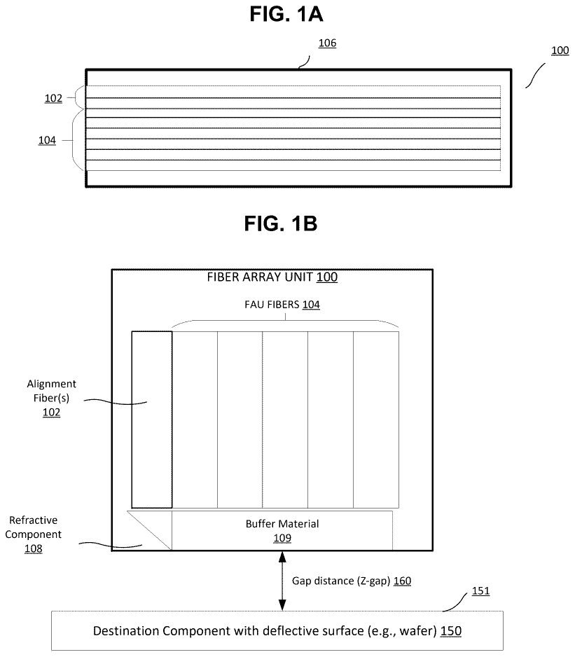

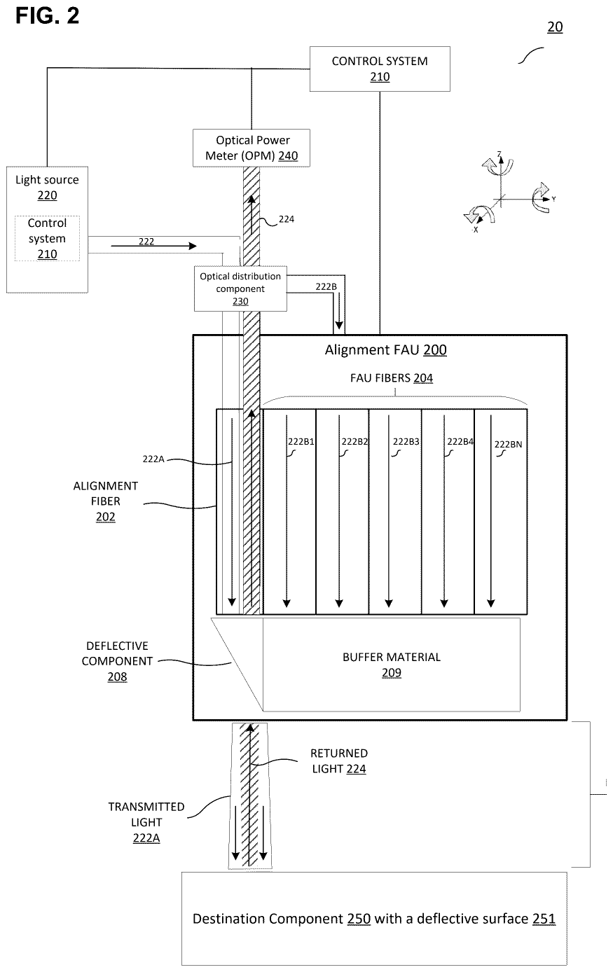

FIGS. 1A-1B illustrates a top view and a front view, respectively, of an example alignment FAU 100, according to at least one example embodiment. As shown in FIGS. 1A and 1B, the alignment FAU 100 includes a set of one or more alignment fibers 102, a set of one or more optical fibers 104 (also referred to as “FAU fibers”), a substrate 106, a refractive component 108, and a buffer material 109. According to embodiments, the alignment fiber(s) 102 and the FAU fibers 104 are disposed in the substrate 106.

As shown in FIG. 1B, the alignment FAU 100 is arranged or aligned with a destination component 150 (e.g., a wafer) having a deflective surface 151. The alignment FAU 100 transmits light from a light source (also referred to as “emitted light”) to the destination component 150 in an optical communication system. As shown in FIG. 1B, the alignment FAU 100 and the destination component 150 may be spaced at a distance in first orientation (e.g., in a Z-axis direction) 160, also referred to as the “gap distance” or “Zgap distance”. According to embodiments, the FAU fibers 104 are configured to transmit a first portion of an emitted light (e.g., from a light source such as a laser) to the destination component 150. In an embodiment, the first portion of light emitted by the FAU fibers 104 is transmitted via a buffer material 109 (e.g., a lens, prism, etc.).

According to embodiments, the one or more alignment fibers 102 are arranged in a parallel orientation relative to the FAU fibers 104. The one or more alignment fibers 102 are configured to transmit a second portion of the emitted light from a light source to the destination component and transmit at least a portion of returned light (e.g., a portion of the deflected or reflected light) received from the deflective surface 151 of the destination component 150. As shown in FIG. 1B, the refractive component 108 (e.g., a lens, a prism, a lens plus prism, etc.) is disposed in the optical communication path between the one or more alignment fibers 102 and the destination component 150. In one example, the refractive component 108 of the alignment FAU 100 is composed of a material having a same refractive index as the one or more alignment fibers 102. In an embodiment, the refractive component 108 is disposed in the aforementioned optical communication path via 3D printing or other disposition technique. According to embodiments, the refractive component 108 is configured to fold the second portion of the emitted light transmitted by the one or more alignment fibers 102 in a perpendicular orientation relative to the deflective surface 151 of the destination component 150.

According to embodiments, an alignment (relative angles and spacing) between the alignment FAU 100 and the destination component 150 can be adjusted to optimize the amount of light transmitted by the alignment FAU 100 to the destination component 150. The greater the level of non-perpendicularity between the alignment FAU 100 and the destination component 150, the more transmitted light that is deflected by the deflective surface 151 of the destination component 150, and the less light that is returned and collected by the alignment fibers 102. According to embodiments, in a target or optimal alignment, the light transmitted from a light source via the alignment fibers 102 and FAU fibers 104 of the alignment FAU 100 is perpendicular (e.g., in a 0° incidence arrangement) to the deflective surface 151 of the destination component 150, such that the light that is returned back to the alignment FAU 100 is maximized (i.e., at or above a target or threshold level), as described in greater detail below.

According to embodiments, the one or more alignment fibers 102 advantageously collect and transmit at least a portion of the returned light (i.e., the light that deflects or reflects off of the deflective surface 151 of the destination component 150. Advantageously, as described in greater detail below, the returned light transmitted via the one or more alignment fibers 104 can be measured and used to make adjustments to one or more tilt angles associated with the relative positioning of the alignment FAU 100 and the destination component 150 and/or the Zgap distance 160 to establish an optimized alignment between the alignment FAU 100 and the destination component 150.

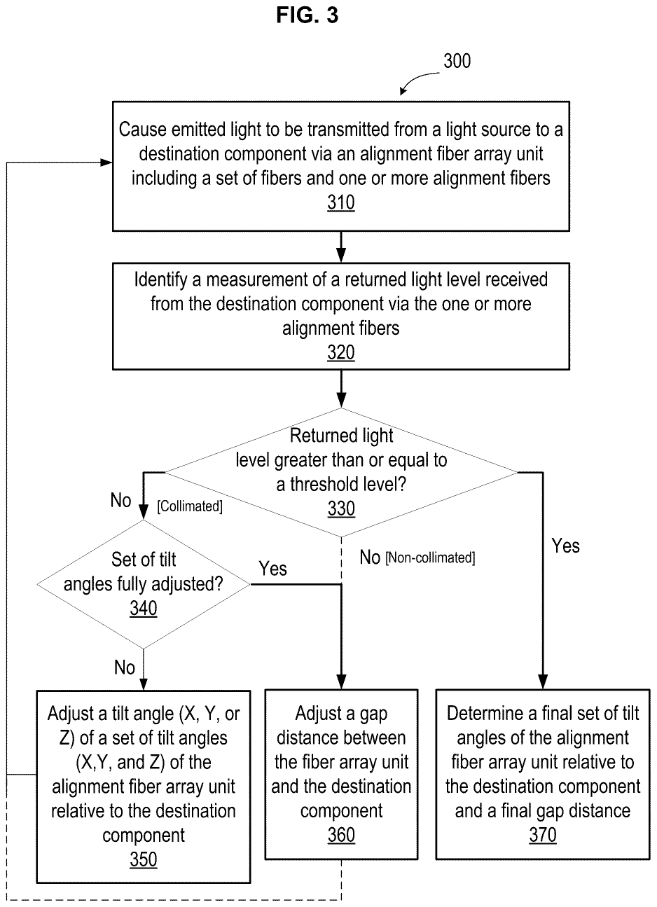

FIG. 2 illustrates an example system 20 to control an alignment between an alignment FAU 200 (e.g., alignment FAU 100 of FIGS. 1A and 1B) and a destination component 250 (e.g., destination component 150 of FIG. 1B), according to one or more embodiments of the present disclosure. The system 20 can be implemented in a testing or packaging environment associated with the alignment FAU 200 and/or the destination component 250. According to embodiments, the system 20 includes the alignment FAU 200 including an alignment fiber 202 (e.g., the one or more alignment fibers 102 of FIGS. 1A and 1B) and one or more FAU fibers 204 (e.g., the one or more FAU fibers 104 of FIGS. 1A and 1B), the destination component 250, a control system 210, a light source 220 (e.g., a laser), an optical distribution component 230, and an optical power meter 240. According to embodiments, as shown in FIG. 2, the control system 210 may be part of the light source 220 (as depicted by the dashed lines) or a separate sub-system of the system 200.

According to embodiments, a light source 220 generates emitted light 222 that is transmitted to the alignment FAU 200 via optical distribution component 230. As shown in FIG. 2, the alignment fiber 202 transmits a portion (222A) of the emitted light 222 to the destination component 250 via a refractive component 208 (e.g., refractive component 108 of FIG. 1B). As shown in FIG. 2, the array of FAU fibers 204 transmits a portion (222B including 222B1, 222B2 . . . 222BN) of the emitted light 222 to the destination component 250 via buffer materials 209.

According to embodiments, as shown in FIG. 2, the refractive component 208 is arranged or disposed in the optical communication path between the alignment fiber 202 and the destination component 250. For example, the refractive component 208 may be 3D printed or otherwise disposed at an end of the alignment fiber 202. In an example, the refractive component 208 may be composed of a material having a same refractive index as the alignment fiber 202. According to an embodiment, the refractive component 208 may be disposed in the optical communication path such that the light portion 222A that is emitted by the alignment fiber 202 is folded such that it is 0° degree incident relative to the destination component 250 (e.g., perpendicular to the flat deflective surface 251 of the destination component 250).

According to embodiments, when the light portion 222A transmitted by the alignment fiber 204 via the refractive component 208 interacts with the deflective surface 251 of the destination component 250, at least a portion of that light is returned (returned light 224) to the alignment fiber 204. According to embodiments, the amount of returned light 224 that is deflected and returned to the alignment fiber 204 is a function of one or more of one or more tilt angles (e.g., X, Y, and/or Z tilt angles) corresponding to the relative arrangement of the alignment FAU 200 and the destination component 250 and/or the Zgap distance 260 between the alignment FAU 200 and the destination component 250.

According to embodiments, the returned light 224 is transmitted via the alignment fiber 204 to the optical power meter 240 (e.g., via the optical distribution component 230). The optical power meter 240 measures a power level of the returned light 224 (e.g., also referred to as the returned light level). The returned light level measured by the optical power meter 240 is provided to the control system 210.

According to embodiments, the control system 210 includes processing logic to execute an alignment process to adjust an alignment between the alignment FAU 200 and the destination component 250 using the measured returned light level. In an embodiment, the control system 210 compares a level (e.g., a power level) of the returned light 224 measured at a first time (e.g., a first iteration of the alignment process) to a threshold level (e.g., a threshold power level). According to embodiments, when the returned light level is greater than or equal to the threshold power level, the control system 210 determines that the alignment FAU 200 and the destination component are in a target alignment. For example, when in a target alignment arrangement, the portion of emitted light 222A transmitted via the alignment fiber 202 and refractive component is perfectly (or approximately perfectly) perpendicular to the deflective surface 251 of the destination component 250, such that the power level of the measured returned light 224 is substantially equal to the transmitted light portion 222A. In this instance, the control system 210 determines that the power level of the measured returned light 224 is greater than or equal to the threshold level (e.g., in a target or optimal alignment).

According to embodiments, the control system 210 may determine that the measured returned light 224 level is below the threshold level, indicating that the alignment FAU 200 and the destination component 250 are not in the target alignment. In response to determining this non-optimal alignment, the control system 210 executes operations to adjust one or more parameters associated with the alignment FAU 200 and/or destination component 250 to adjust the alignment therebetween.

According to embodiments, the control system 210 can adjust one or more parameters of the following parameters as part of the alignment process including one or more of a set of relative tilt angles associated with a current alignment of the alignment FAU 200 and the destination component 250; the Zgap distance between the FAU 200 and the destination component 250; or both.

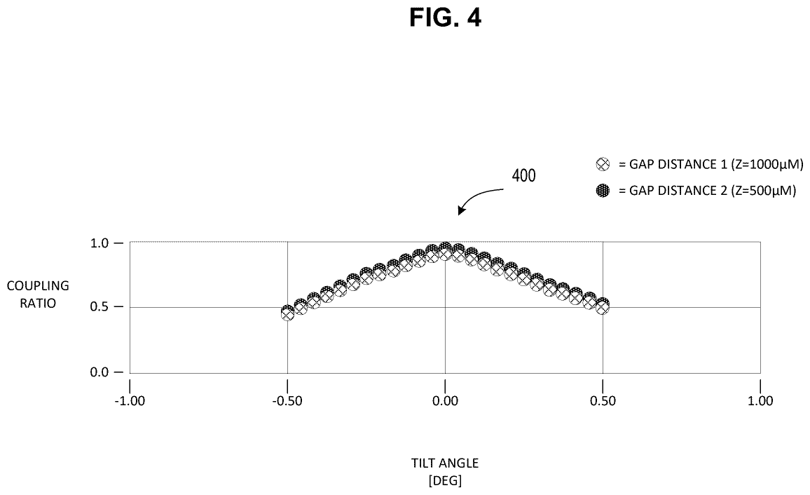

FIG. 3 is a flow diagram of an example method 300 of adjusting one or more parameters to establish a target alignment between an alignment FAU (e.g., alignment FAU 100 of FIGS. 1A and 1B, alignment FAU 200 of FIG. 2) and a destination component (e.g., destination component 150 of FIG. 1B, destination component 250 of FIG. 2), according to embodiments of the present disclosure. The method 300 can be performed by processing logic comprising hardware, software, firmware, or any combination thereof. In at least one embodiment, the method 300 is performed by the control system 210 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. The method 300 can help prevent collisions by continuously monitoring the FAU movement and location/positioning relative to one or more other components in a system (e.g., the destination component). The continuous monitoring ensures that any potential collisions are detected early.

At operation 310, the processing logic (e.g., control system 210 of FIG. 2) causes emitted light (e.g., emitted light 222 of FIG. 2) to be transmitted from a light source (e.g., laser 220 of FIG. 2) to a destination component (e.g., destination component 150 of FIG. 1B, destination component 250 of FIG. 2) via a fiber array unit (e.g., alignment FAU 100 of FIGS. 1A and 1B, alignment FAU 200 of FIG. 2) including a set of fibers (e.g., FAU fibers 104 of FIGS. 1A and 1B, FAU fibers 204 of FIG. 2) and one or more alignment fibers (e.g., alignment fiber(s) 102 of FIGS. 1A and 1B, alignment fiber(s) 202 of FIG. 2). According to embodiments, the emitted light may be transmitted at a first power level that is tracked and stored by the processing logic. In an embodiment, the one or more alignment fibers transmit a first portion of the emitted light (e.g., portion 222A) and the set of fibers (e.g., FAU fibers 104, 204) transmits a second portion of the emitted light (e.g., portions 222B1 through 222BN). According to embodiments, the first portion of emitted light (e.g., portion 222A) is transmitted via the one or more alignment fibers through a refractive component (e.g., refractive component 108, 208 of FIGS. 1B and 2). According to embodiments, the refractive component folds the first portion of emitted light that is transmitted to the destination component (e.g., transmitted light 222A that is transmitted to destination component 250 in FIG. 2). In an embodiment, the refractive component folds the transmitted light 222A to have an incident angle of 0°.

At operation 320, the processing logic identifies a measurement of a returned light level received from the destination component via the one or more alignment fibers. In an embodiment, as shown in FIG. 2, returned light 224 is deflected by the deflective surface of the destination component and transmitted by the one or more alignment fibers to a measurement component (e.g., optical power meter 240 of FIG. 2). The measurement component (e.g., optical power meter 240 of FIG. 2) measures a characteristic of the returned light 224. In an embodiment, the optical power meter 240 of FIG. 2 measures a power level of the returned light 224 (herein the “returned light level”).

At operation 330, the processing logic compares the returned light level to a threshold level (e.g., a threshold power level) to determine if the returned light level is greater than or equal to the threshold level. According to embodiments, if the alignment fiber array unit and the destination component as currently arranged (i.e., as defined by the one or more alignment parameters including a set of tilt angle values and a current Zgap distance) are in a target or desired alignment, the measured returned light level is greater or equal to the threshold level (e.g., indicating that the transmitted light 222 is substantially perpendicular to the flat deflective surface of the destination component.

If it is determined at operation 330 that the returned light level is less than the threshold level, at operation 340, the processing logic determines if a set of one or more adjustable tilt angles associated with the current alignment of the alignment FAU and the destination component have been fully adjusted. In an embodiment, the set of one or more adjustable tilt angles may be an X tilt angle (e.g., tilt angle X corresponding to rotation relative to an X axis, title angle Y corresponding to rotation relative to a Y axis, and/or tilt angle Z corresponding to rotation relative to a Z axis) of the alignment FAU and/or destination component. According to embodiments, the set of tilt angles that may be adjusted to change the current alignment between the alignment FAU and the destination component may be associated with either the alignment FAU (i.e., the one or more tilt angles of the alignment FAU are adjusted relative to the destination component) or the destination component (i.e., the one or more tilt angles of the destination component are adjusted relative to the alignment FAU).

In an embodiment, the processing logic (e.g., control system 210 of FIG. 2) may maintain an ordered sequence of the one or more tilt angles and corresponding adjustment ranges (e.g., tilt angle X may be adjusted incrementally within a first adjustment range of −N to +N degrees; tilt angle Y may be adjusted incrementally within a second adjustment range of −M to +M degrees; and tilt angle Z may be adjusted incrementally within a third adjustment range of −K to +K). For example, the processing logic may cause one or more incremental adjustments to the set of tilt angles in the following sequence: 1) cause a first set of one or more adjustments to tilt angle X; 2) cause a second set of one or more adjustments to tilt angle Y; and 3) cause a third set of one or more adjustments to tilt angle Z.

According to embodiments, if at operation 340, the processing logic determines that the set of adjustable tilt angles (e.g., one or more of tilt angles X, Y, or Z) have not been fully adjusted (e.g., adjustments in the corresponding adjustment ranges have not been exhausted), the method 300 proceeds to operation 350.

In operation 350, the processing logic adjusts a tilt angle (e.g., X, Y, or Z) of the set of tilt angles (e.g., X, Y, and Y) of the alignment FAU relative to the destination component. Although described in this example as adjusting the tilt angle(s) of the alignment FAU, it is noted that the processing logic can adjust the tilt angle(s) of the destination component relative to the alignment FAU as part of the method 300. In an embodiment, the processing logic may use the ordered sequence of tilt angles to execute a first adjustment of a first tilt angle. For example, the ordered sequence may indicate that the X tilt angles are adjusted first, followed by the Y tilt angles, followed by the Z tilt angles.

According to embodiments, the adjustment in operation 350 may be an incremental adjustment to a first tilt angle. In an embodiment, the incremental adjustment may be of a predetermined or step adjustment amount (e.g., increase or decrease a current title angle by the step adjustment amount) to establish a first adjusted tilt angle. As illustrated in FIG. 3, following each tilt angle adjustment in operation 350, the method 300 returns to operations 310-330. The processing logic iteratively executes operations 310, 320, 330, 340, and 350 until either the returned light level is greater than or equal to the threshold level (at operation 330) or the set of tilt angles have been fully adjusted in their corresponding adjustment ranges (at operation 340).

According to embodiments, if at operation 340 the processing logic determines that each of the adjustable tilt angles (e.g., one or more of tilt angles X, Y, or Z) have been fully adjusted in their corresponding adjustment ranges, the method 300 proceeds to operation 360. At operation 360, the processing logic adjusts a gap distance (e.g., gap distance 160, 260 of FIGS. 1B and 2) by a gap distance increment or step amount (i.e., a gap step amount). For example, following the full adjustment of the set of one or more adjustable tilt angles, the processing logic may decrease the gap distance by the gap step amount to establish an adjusted gap distance. As illustrated in FIG. 3, following each gap distance adjustment in operation 360, the method returns to operations 310-330. According to embodiments, the processing logic can iteratively repeat operations 310, 320, 330, and 360 until the gap distance is fully adjusted (e.g., within an adjustable distance range) or the processing logic determines at operation 330 that the returned light level is greater than or equal to the threshold level.

According to embodiments, if the processing logic determines at operation 330 that the alignment FAU and the destination component are in a target or desired alignment (i.e., the returned light level is greater than or equal to the threshold level), the method 300 proceeds to operation 370. At operation 370, the processing logic determines a final set of tilt angles of the alignment FAU relative to the destination component and a final gap distance between the alignment FAU and the destination component.

Advantageously, the processing logic can iteratively measure a returned light level transmitted by the one or more alignment fibers of the alignment FAU and compare the measured returned light level to the threshold level to determine a final set of tilt angles and final gap distance corresponding to a target or desired alignment between the alignment FAU and the destination component.

According to embodiments, the processing logic may determine a type of emitted light that is transmitted to the destination component via the alignment FAU. For example, the processing logic can determine that the emitted light is collimated or non-collimated. In an embodiment, the processing logic can execute a modified version of method 300, depending on the identified type of emitted light. In an embodiment, if the processing logic determines that the transmitted light is collimated (e.g., the alignment FAU includes one or more collimated alignment fibers), the processing logic can maintain a constant distance and cause adjustments to the set of tilt angles. In an embodiment, if the processing logic determines that the transmitted light is non-collimated (e.g., the alignment FAU includes one or more non-collimated alignment fibers), the processing logic can maintain a set of constant tilt angles and cause one or more adjustments to the gap distance (e.g., execute operation 360 if it is determined that the returned light level is less than the threshold level in operation 330).

According to an embodiment, the method 300 can include operations to adjust the position or location of the alignment FAU such that the alignment FAU is perpendicular to the destination component. In an embodiment, once the alignment FAU and the destination component are perpendicular to one another, the processing logic can adjust the alignment FAU (e.g., rotate the alignment FAU) to establish a set of optimized tilt angles (e.g., tilt angles where a target or desired alignment is achieved (i.e., the returned light level is greater than or equal to the threshold level). For example, the operations can be performed to make the positional adjustment to establish perpendicularity with the destination component and the rotational adjustments of the alignment FAU to establish the set of optimized tilt angles.

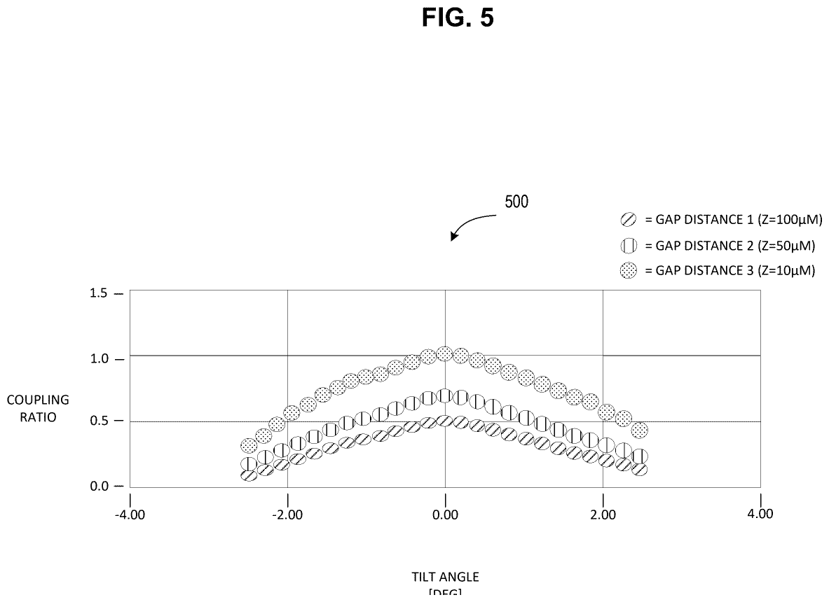

FIG. 4 illustrates an example graph 400 depicting a coupling ratio associated with the optical transmission between the alignment FAU including one or more collimated alignment fibers and the destination component as a function of an example adjustable tilt angle (e.g., an X tilt angle, a Y tilt angle, or a Z tilt angle), at a first gap distance (e.g., a gap distance of 500 μm) and a second gap distance (e.g., a gap distance of 1000 μm). As shown, the coupling ratio (e.g., a proportion of power transferred between the alignment FAU and the destination component) is relatively constant over the range of tilt angle values at the two different gap distances. In this regard, as shown in the graph 400, alignment of the alignment FAU and destination component based on a collimated light beam is correlated to the tilt angle, as compared to the gap distance. According to embodiments, as illustrated by the graph 400, the alignment adjustment process (e.g., method 300 of FIG. 3) when a collimated alignment fiber is employed can executed with the set of tilt angles adjusted as a priority (i.e., perform tilt angle adjustments first, followed by optional adjustments to the gap distance).

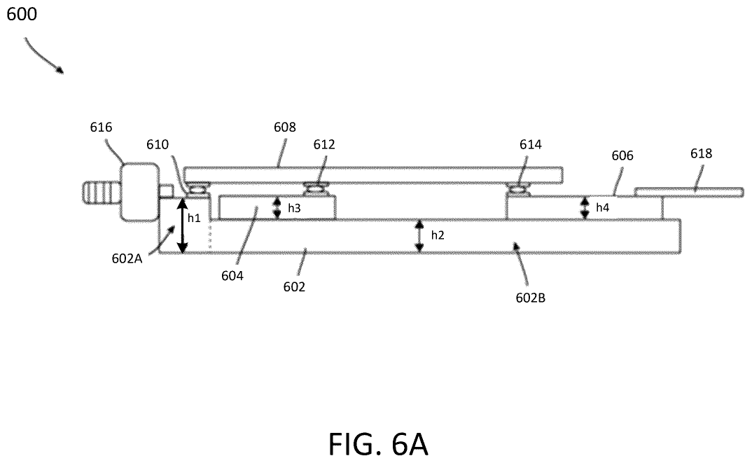

FIG. 5 illustrates an example graph 500 depicting a coupling ratio associated with the optical transmission between the alignment FAU including one or more non-collimated alignment fibers (e.g., single-mode fiber (SMF) 28) and the destination component as a function of an example tilt angle (e.g., an X tilt angle, a Y tilt angle, or a Z tilt angle), at a first gap distance (e.g., a gap distance of 10 μm), at a second gap distance (e.g., a gap distance of 50 μm), and at a third gap distance (e.g., a gap distance of 100 μm). As shown, the coupling ratio varies as a function of the different gap distances. In this regard, as shown in the graph 500, alignment of the alignment FAU and destination component based on a non-collimated light beam is correlated to the gap distance, as compared to the tilt angle(s). According to embodiments, as illustrated by the graph 500, the alignment adjustment process (e.g., method 300 of FIG. 3) when a non-collimated alignment fiber is employed can executed with the gap distance adjusted as a priority (i.e., perform gap distance adjustments first, followed by optional adjustments to the set of one or more tilt angles).

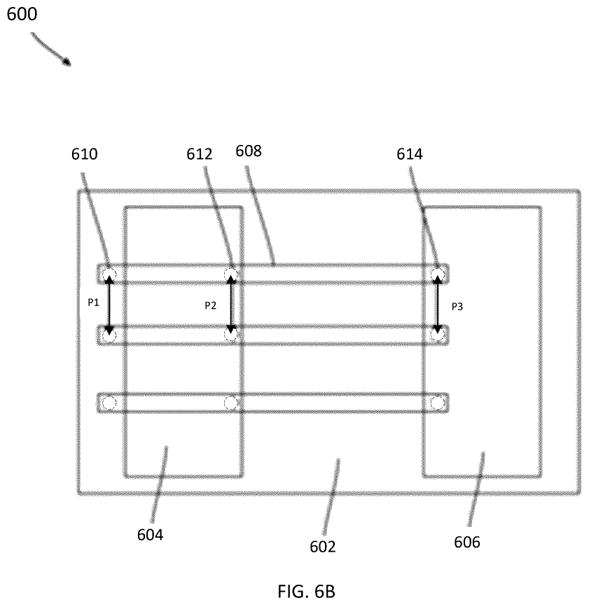

FIGS. 6A and 6B illustrate a cross-sectional view and a top plan view, respectively, of an example destination component (e.g., destination component 150, 250), where the destination component can include one or more optoelectronic components 600. In some embodiments, the optoelectronic component 600 may include a substrate 602. The substrate 602, for example, may be a printed circuit board, a metal carrier, an organic carrier, and/or a ceramic carrier. In some embodiments, the height of the substrate 602 may vary. In this regard, for example, a first portion 602A of the substrate 602 may have a height h1 and a second portion 602B of the substrate 602 may have a height h2. In some embodiments, an electronic integrated circuit 604 may be supported by the substrate 602. The electronic integrated circuit 604 may be any type of electronic integrated circuit. For example, the electronic integrated circuit 604 may be a digital signal processor, a modulator driver, and/or a transimpedance amplifier. In some embodiments, there may be more than one electronic integrated circuit supported by the substrate 602. In some embodiments, the electronic integrated circuit 604 may have a height h3. In some embodiments, the optoelectronic component 600 may support more than one electronic integrated circuit.

In some embodiments, a photonic integrated circuit 606 may be supported by the substrate 602. The photonic integrated circuit 606 may be any type of photonic integrated circuit. For example, the photonic integrated circuit 606 may be an electro-optic modulator, a photodiode, a transmitter optical sub assembly and/or a receiver optical sub assembly. In some embodiments, the photonic integrated circuit 606 may comprise graphene. In some embodiments, there may be more than one photonic integrated circuit 606 supported by the substrate 602. In some embodiments, the photonic integrated circuit 606 may have a height h4. In some embodiments, the heights h1, h2, h3, and h4 may be different. For example, depending on the electronic integrated circuit and photonic integrated circuit 606 used, the height h3 may be greater that the height h4, or vice versa.

In some embodiments, the optoelectronic component 600 may include one or more optical fibers 618 connected to the photonic integrated circuit 606. The one or more optical fibers 618 may be configured to connect the optoelectronic component 600 to other optical components and/or devices. In some embodiments, a port 616 may be connected to the substrate 602. The port 616 may be configured to connect the optoelectronic component 600 to other electronic components and/or devices. In some embodiments, the optoelectronic component 600 may be configured to operate at speeds greater than 25 Gb/s.

The optoelectronic component 600 may include a plurality of substrate interconnect connectors 610 disposed on the substrate 602, a plurality of electronic integrated circuit interconnect connectors 612 disposed on the electronic integrated circuit 604, and a plurality of photonic integrated circuit interconnect connectors 614 disposed on the photonic integrated circuit 606. The plurality of substrate interconnect connectors 610, the plurality of electronic integrated circuit interconnect connectors 612, and the plurality of photonic integrated circuit interconnect connectors 614 may comprise any conductive material (e.g., conductive glue and/or solder). In some embodiments, the plurality of substrate interconnect connectors 610, the plurality of electronic integrated circuit interconnect connectors 612, and the plurality of photonic integrated circuit interconnect connectors 614 may be flexible. In other words, in some embodiments, the plurality of substrate interconnect connectors 610, the plurality of electronic integrated circuit interconnect connectors 612, and the plurality of photonic integrated circuit interconnect connectors 614 may be manipulated such that each may be capable of taking various shapes. In some embodiments, the plurality of substrate interconnect connectors 610 may have a pitch p1, the plurality of electronic integrated circuit interconnect connectors 612 may have a pitch p2, and the plurality of photonic integrated circuit interconnect connectors 614 may have a pitch p3. The pitch may refer to the distance between each of the plurality of interconnect connectors. In some embodiments, the pitch p1, pitch p2, pitch p3, may be different. For example, the pitch p2 of the plurality of electronic integrated circuit interconnect connectors 612 may be 1.25 mm while the pitch p3 of the plurality of photonic integrated circuits may be 1.5 mm.

In some embodiments, the optoelectronic component 600 may include a first plurality of cable connectors 608. In some embodiments, each of the first plurality of cable connectors 608 may be connected to and in communication with the substrate 602, the electronic integrated circuit 604, and the photonic integrated circuit 606 via respective interconnect connectors. In other words, the first plurality of cable connectors 608 may be connected to and in communication with the substrate 602 via the plurality of substrate interconnect connectors 610, the electronic integrated circuit 604 via the plurality of electronic integrated circuit interconnect connectors 612, and the photonic integrated circuit 606 via the plurality of photonic integrated circuit interconnect connectors 614. As such, the first plurality of cable connectors 608 may be used to facilitate communication between the substrate 602, the electronic integrated circuit 604, and the photonic integrated circuit 606.

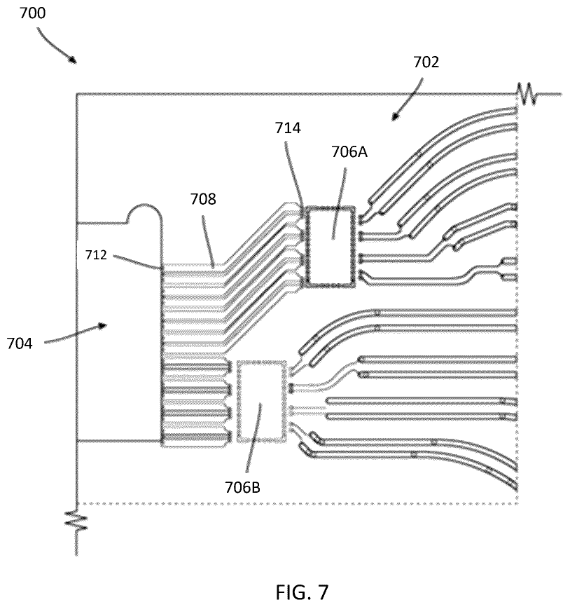

In some embodiments, the first plurality of cable connectors 608 may define a first layout. In some embodiments, the first layout may define the overall connectivity of the optoelectronic component 600. For example, with reference to FIG. 7, the connectivity defined by the first layout in the illustrated example is such that an electronic integrated circuit 704 is connected to a first photonic integrated circuit 706A and a second photonic integrated circuit 706B via cable connectors 708. In some embodiments, the first plurality of cable connectors 608 may be interchangeable with other pluralities of cable connectors that define different layouts. The different layouts may alter the overall connectivity of the optoelectronic component 600. For example, the first plurality of cable connectors 608 may be interchangeable with a second plurality of cable connectors that define a second layout which modifies the overall connectivity of the optoelectronic component 600. In this way, the optoelectronic component 600 may be easily modified to obtain desired capabilities by interchanging cable connectors.

In some embodiments, the first plurality of cable connectors 608 may be flexible. This may help ensure that the first plurality of cable connectors 608 may be used with a variety of substrates, electronic integrated circuits, and photonic integrated circuits. For example, the substrate, electronic integrated circuit, and/or photonic integrated circuit may be from different manufactures, may be a different type of integrated circuit or substrate, and/or may have different capabilities. For example, the substrate 602, electronic integrated circuit 604, and the photonic integrated circuit 606 may have different heights (e.g., height h3 of the electronic integrated circuit 604 may be greater than height h4 of the photonic integrated circuit 606). The flexibility of the first plurality of cable connectors 608 enables the first plurality of cable connectors 608 to bend as needed, such that components of the optoelectronic component 600 with different heights may be accommodated and connections may be made without any modifications to the configuration of the optoelectronic component 600 itself. Additionally, the flexibility of the first plurality of cable connectors 608 may enable the first plurality of cable connectors 608 to be used with a variety of substrates, electronic integrated circuits, and photonic integrated circuits that have interconnect connectors with different pitches. For example, if the pitch p2 of the plurality of electronic integrated circuit interconnect connectors 612 is less than the pitch p3 of the plurality of photonic integrated circuit interconnect connectors 614, the first plurality of cable connectors 608 may bend to account for the differences in pitch and connect the electronic integrated circuit 604 to the photonic integrated circuit 606.

With reference to FIG. 7 a portion of an example optoelectronic component 700 is illustrated. For example, the example optoelectronic component 700 may be part of a 1.6 Tb/s demonstrator. The example optoelectronic component 700 includes a substrate 702, an electronic integrated circuit 704 supported by the substrate 702, a first photonic integrated circuit 706A supported by the substrate 702, and a second photonic integrated circuit 706B supported by the substrate 702. The example optoelectronic component 700 may include a plurality of electronic integrated circuit interconnect connectors 712 disposed on the electronic integrated circuit 704 and a plurality of photonic integrated circuit interconnect connectors 714 disposed on the first photonic integrated circuit 706A and the second photonic integrated circuit 706B. The electronic integrated circuit 704 may be connected to and in communication with the first photonic integrated circuit 706A and the second photonic integrated circuit 706B via a plurality of cable connectors 708. In the example optoelectronic component 700, the electronic integrated circuit 704 and the first photonic integrated circuit 706A are situated on the substrate 702 such that the plurality of electronic integrated circuit interconnect connectors 712 and the plurality of photonic integrated circuit interconnect connectors 714 disposed on the first photonic integrated circuit 706A are not aligned with each other (e.g., one is not disposed directly opposite to the other). In such a situation, the flexibility of the plurality of cable connectors 708 facilitating communication between the electronic integrated circuit 704 and the first photonic integrated circuit 706A may allow the electronic integrated circuit 704 and the first photonic integrated circuit 706A to be connected through manipulation of the cable connectors to accommodate the misaligned locations.

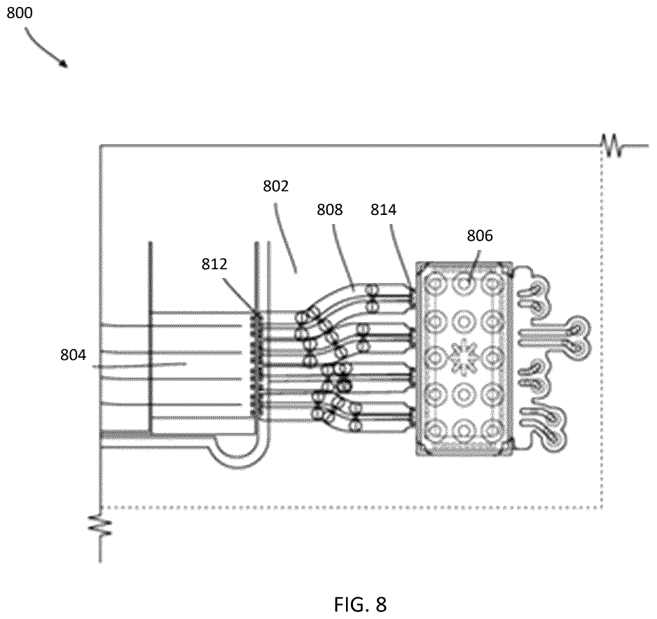

With reference to FIG. 8, another example optoelectronic component 800 is illustrated. For example, the example optoelectronic component 800 may be part of an octal small form factor pluggable (OSFP) transceiver. The example optoelectronic component 800 includes a substrate 802, an electronic integrated circuit 804 supported by the substrate 802, and a photonic integrated circuit 806 supported by the substrate 802. The example optoelectronic component 800 may include a plurality of electronic integrated circuit interconnect connectors 812 disposed on the electronic integrated circuit 804 and a plurality of photonic integrated circuit interconnect connectors 814 disposed on the photonic integrated circuit 806. The electronic integrated circuit 804 may be connected to and in communication with the photonic integrated circuit 806 via a plurality of cable connectors 808. In the example optoelectronic component 800, the pitch of the plurality of the electronic integrated circuit interconnect connectors 812 and the plurality of photonic integrated circuit interconnect connectors 814 is different. In this case, the flexibility of the plurality of cable connectors 808 facilitating communication between the electronic integrated circuit 804 and the photonic integrated circuit 806 may be such that the electronic integrated circuit 804 and the photonic integrated circuit 806 can be connected despite the differences in pitch, such as through bending or other reshaping of the cable connectors to accommodate the differences.

According to embodiments, the optoelectronic component 800 (e.g., destination component) can include a light-transmitting medium. When the light-transmitting medium is silicon, a suitable insulator may be used which includes, but is not limited to, silica and a suitable substrate may be used which includes, but is not limited to a silicon substrate. A silicon-on-insulator wafer is a suitable platform for an optical device having a silicon light-transmitting medium positioned over a base having a silica insulator and a silicon substrate.

According to embodiments, the destination component can include one or more waveguides that carry light signals to and/or from one or more optical components. Examples of optical components that can be included on the destination component include, but are not limited to, one or more components selected from a group consisting of facets through which light signals can enter and/or exit a waveguide, entry/exit ports through which light signals can enter and/or exit a waveguide from above or below the destination component, multiplexers for combining multiple light signals onto a single waveguide, demultiplexers for separating multiple light signals such that different light signals are received on different waveguides, optical couplers, optical switches, lasers that act as a source of a light signal, amplifiers for amplifying the intensity of a light signal, attenuators for attenuating the intensity of a light signal, modulators for modulating a signal onto a light signal, modulators that convert a light signal to an electrical signal, and vias that provide an optical pathway for a light signal traveling through the destination component from a bottom side of the destination component to a top side of the destination component. Additionally, the destination component can optionally, include electrical components. For instance, the destination component can include electrical connections for applying a potential or current to a waveguide and/or for controlling other components on the destination component.

According to embodiments, the alignment fiber array unit 100, 200 of FIGS. 1A, 1B, and 2 may be manufactured using Silicon Photonics (SiP) technology. SiP technology enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally comprise a smaller diameter than the optical fibers. As such, a “world-to-chip” interface problem often arises in SiP technologies where coupling of light between Si wire waveguides and optical fibers, and vice versa, is generally inefficient.

Traditionally, for fiber-to-chip coupling, a fiber coupling technique using spot-size converters (SSCs) or grating couplers is employed. However, grating couplers for fiber-to-chip coupling typically provide a narrow bandwidth and/or an undesirable polarization sensitivity for certain optical applications. Furthermore, SSCs and grating couplers for fiber-to-chip coupling are generally attached to the chip through an adhesive bonding technique that results in a silicon communication chip with bundles of fibers attached thereto, resulting in increased complexity for handling and/or assembly of the chips onto other optical systems. Additionally, wafers for traditional SiP devices are generally diced (e.g., fully cut through) to create an edge for the wafer to expose waveguide facets and/or to facilitate butt attachment of the SiP device to an external device.

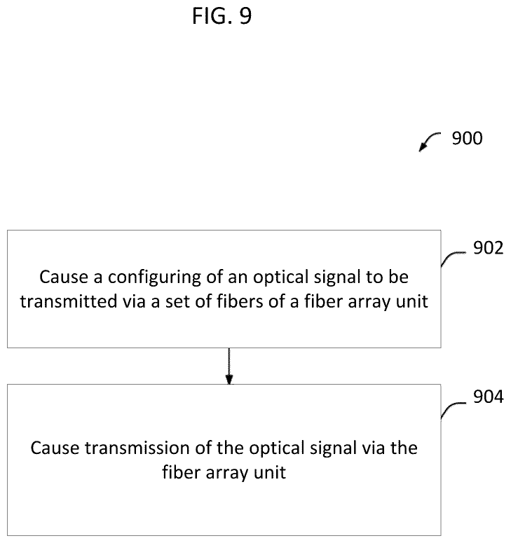

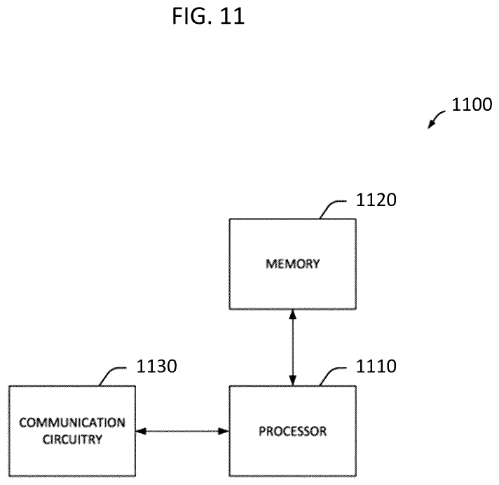

FIG. 9 is a flowchart illustrating an example method 900 for providing optical communications via a fiber array unit (e.g., alignment fiber array unit 100, 200 of FIGS. 1A, 1B, and 2) in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments additional optional operations may also be included. It should be appreciated that each of the modifications, optional additions, or amplifications described herein may be included with the operations herein either alone or in combination with any others among the features described herein. The operations illustrated in FIG. 9 may, for example, be performed by an example computing system (e.g., computing system 1100 of FIG. 11), such as control system 210 of FIG. 2. In certain embodiments, the control system (e.g., control system 210 of FIG. 2) can be embedded in an EIC. In certain embodiments, the control system can be embedded in an optical module (e.g., a transceiver module). In some embodiments, the control system is a firmware computing system embedded in an EIC and/or an optical module (e.g., a transceiver module). In one or more embodiments, one or more of the operations illustrated in FIG. 9 may, for example, be performed by an EIC.

In one or more embodiments, at operation 902, the control system causes a configuring of an optical signal to be transmitted via a set of fibers (e.g., alignment fiber(s) 102, 202 and FAU fibers 104, 204 of FIGS. 1A, 1B, and 2) of a fiber array unit (e.g., alignment fiber array unit 100, 200 of FIGS. 1A, 1B, and 2). In one or more embodiments, at operation 904, the control system causes transmission of the optical signal (e.g., emitted light) via the fiber array unit, where a refractive component (e.g., refractive component 108, 208 of FIGS. 1A, 1B, and 2) is disposed in optical communication with the one or more alignment fibers of the alignment fiber array unit and a micro-optical passive element (e.g., buffer material 109, 209 of FIGS. 1A, 1B, and 2 is disposed (e.g., mounted) in optical communication with the set of FAU fibers (e.g., FAU fibers 104, 204 of FIGS. 1A, 1B, and 2) to direct the optical signal from the alignment fiber array unit to the destination component, as described in detail above.

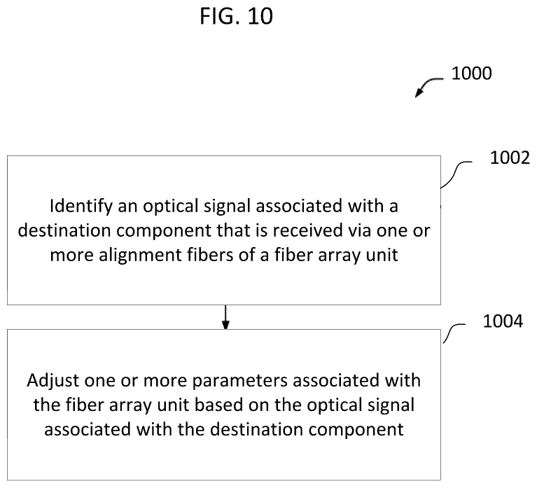

FIG. 10 is a flowchart illustrating an example method 1000 for providing optical communications via a fiber array unit (e.g., alignment fiber array unit 100, 200 of FIGS. 1A, 1B, and 2) in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments additional optional operations may also be included. It should be appreciated that each of the modifications, optional additions, or amplifications described herein may be included with the operations herein either alone or in combination with any others among the features described herein. The operations illustrated in FIG. 10 may, for example, be performed by an example computing system, such as control system 210 of FIG. 2. In certain embodiments, the control system (e.g., control system 210 of FIG. 2) can be embedded in an EIC. In certain embodiments, the control system can be embedded in an optical module (e.g., a transceiver module). In some embodiments, the control system is a firmware computing system embedded in an EIC and/or an optical module (e.g., a transceiver module). In one or more embodiments, one or more of the operations illustrated in FIG. 10 may, for example, be performed by an EIC.

In one or more embodiments, at operation 1002, the control system (e.g., which can be implemented as the computing system 1100 of FIG. 11) identifies an optical signal (e.g., the returned light transmission 224 of FIG. 2) associated with the destination component (e.g., light deflected by the deflective surface 151, 251 of the destination component 150, 250 of FIGS. 1A, 1B, and 2). As described above, the optical signal can be transmitted via the one or more alignment fibers (e.g., alignment fibers 102, 202 of FIGS. 1A, 1B, and 2) of a fiber array unit (e.g., alignment fiber array unit 100, 200 of FIGS. 1A, 1B, and 2). In an embodiment, the refractive component 108, 208 of FIGS. 1A, 1B, and 2 is configured to direct the optical signal from the deflective surface of the destination component to the one or more alignment fibers of the fiber array unit. In one or more embodiments, at operation 1004, the control system adjusts one or more parameters (e.g., tilt angle and/or gap distance) associated with the fiber array unit based on the optical signal associated with the destination component, as described above in detail with reference to FIG. 3.

FIG. 11 illustrates an example computing system 1100 associated with control system 210 of FIG. 2. In an embodiment, the computing system 1100 may be implemented in a testing or packaging environment to enable the alignment of a fiber array unit and a destination component, as described in detail with reference to FIG. 3. In some cases, the computing system 1100 may be a firmware computing system communicatively coupled with, and configured to control, one or more circuit modules associated with an optical module (e.g., a silicon photonics transceiver module). For example, the computing system 1100 may be a firmware computing system and/or a controller computing system communicatively coupled with one or more circuit modules, such as an EIC and/or an optical module (e.g., fiber array unit 100, 200 of FIGS. 1A, 1B, and 2). The computing system 1100 (e.g., control system 210 of FIG. 2) may include or otherwise be in communication with a processor 1110, a memory circuitry 1120, and communication circuitry 1130. In some embodiments, the processor 1110 (which may include multiple or co-processors or any other processing circuitry associated with the processor) may be in communication with the memory circuitry 1120. The memory circuitry 1120 may comprise non-transitory memory circuitry and may include one or more volatile and/or non-volatile memories. In some examples, the memory circuitry 1120 may be an electronic storage device (e.g., a computer readable storage medium) configured to store data that may be retrievable by the processor 1110. In some examples, the data stored in the memory circuitry 1120 may include classical communication protocol data and/or quantum communication protocol data, or the like for enabling the apparatus to carry out various functions or methods in accordance with embodiments of the present disclosure, described herein.

In some examples, the processor 1110 may be embodied in a number of different ways. For example, the processor may be embodied as one or more of various hardware processing means such as a microprocessor, a coprocessor, a digital signal processor (DSP), a controller, or a processing element with or without an accompanying DSP. The processor 1110 may also be embodied in various other processing circuitry including integrated circuits such as, for example, an FPGA (field programmable gate array), a microcontroller unit (MCU), an ASIC (application specific integrated circuit), a hardware accelerator, or a special-purpose electronic chip. Furthermore, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading. In some embodiments, the processor 1110 is a microprocessor.

In an example embodiment, the processor 1110 may be configured to execute instructions, such as computer program code or instructions, stored in the memory circuitry 1120 or otherwise accessible to the processor 1110. Alternatively or additionally, the processor 1110 may be configured to execute hard-coded functionality. As such, whether configured by hardware or software instructions, or by a combination thereof, the processor 1110 may represent a computing entity (e.g., physically embodied in circuitry) configured to perform operations according to an embodiment of the present disclosure described herein. For example, when the processor 1110 is embodied as an ASIC, FPGA, or similar, the processor may be configured as hardware for conducting the operations of an embodiment of the disclosure. Alternatively, when the processor 1110 is embodied to execute software or computer program instructions, the instructions may specifically configure the processor 1110 to perform the algorithms and/or operations described herein when the instructions are executed. However, in some cases, the processor 1110 may be a processor of a device (e.g., a mobile terminal, a fixed computing device, a semiconductor fabrication device, a robot device, etc.) specifically configured to employ an embodiment of the present disclosure by further configuration of the processor using instructions for performing the algorithms and/or operations described herein. The processor 1110 may further include a clock, an arithmetic logic unit (ALU) and logic gates configured to support operation of the processor 1110, among other things.

The computing system 1100 may optionally also include the communication circuitry 1130. The communication circuitry may be any means embodied in either hardware or a combination of hardware and software that is configured to receive and/or transmit data from/to a network and/or any other device or module in communication with the computing system 1100. In this regard, the communication interface may include, for example, supporting hardware and/or software for enabling communications. As such, for example, the communication circuitry 1130 may include a communication modem and/or other hardware/software for supporting communication via cable, universal serial bus (USB), integrated circuit receiver, or other mechanisms.

According to embodiments, fiber array units (e.g., alignment fiber array unit 100, 200 of FIGS. 1A, 1B, and 2) and/or destination components (e.g., destination components 150, 250 of FIGS. 1A, 1B, and 2) may be deployed in a datacenter. Datacenters and other networking systems may include connections between datacenters, switch systems, servers, racks, and devices in order to provide for signal transmission between one or more of these elements. These connections may be made using cables, transceivers, interconnects, interposers, and connector assemblies. For high bandwidth applications and/or connections over long distances, high powered optical communications may be preferred to ensure signal transmission integrity.

Datacenters may include multiple network switches in a particular topology, such as a fat tree topology, a slim fly topology, a dragonfly topology, multi-level fat-trees, fat-flys, Benes, Clos, meshes, and tori and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

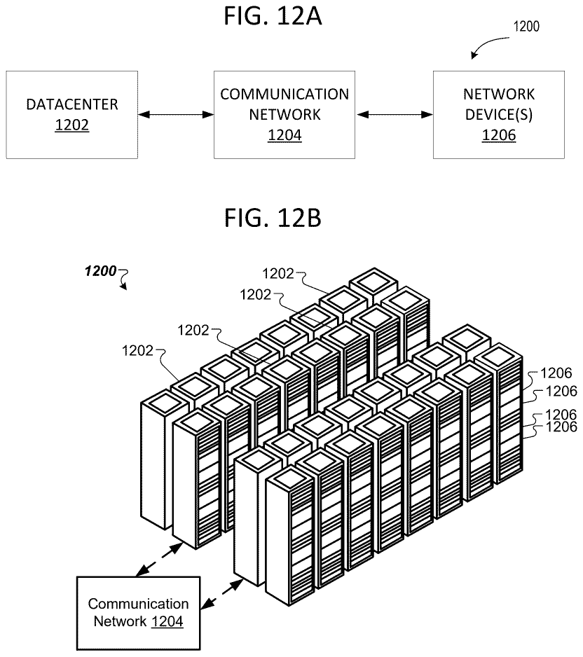

As described above, datacenters, high performance computing clusters, and/or the like are often formed of various computing components or networked devices, and communication networks formed of electrical and/or optical devices may be used to enable communication between the networked devices forming these implementations. With reference to FIGS. 12A-12B, for example, a network architecture 1200 may include a datacenter 1202, a communication network 1204, and network device(s) 1206. The network architecture 1200 may illustrate a general computing architecture within which more specific systems and/or subsystems may function. Although described hereinafter with reference to a network architecture 1200 and/or datacenter 102 within which the embodiments of the present disclosure may be implemented, the present disclosure contemplates that the transceiver resiliency devices and techniques described herein may be applicable to any communication implementation without limitation.

For example, the datacenter 1202 may be a centralized facility designed to house computing resources and related components. The datacenter 1202 may operate to support the infrastructure required for advanced computational tasks, for efficient, secure, and reliable operations. The datacenter 1202 may include the building and structural components, including power supplies, cooling systems, fire suppression systems, and physical security measures that are configured to maintain optimal operating conditions and/or protect the equipment from environmental hazards and unauthorized access. An example datacenter 1202 may include high-performance servers or compute nodes, often arranged in racks, such as those illustrated in FIG. 1B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The datacenter 1202 may include high-speed network equipment, such as network switches, routers, firewalls, and/or the like to facilitate fast and secure data transmission within the datacenter 1202 (e.g., between the servers or compute nodes) and between external networks. The datacenter 1202 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 1202 may support high-performance computing tasks. Examples of various network topologies may include hierarchical networking topologies such as the fat tree topology, Slim Fly topology, Dragonfly topology, and/or the like.

The communication network 1204 may communicably couple the datacenter 1202 with network device(s) 1206 and other external devices for data exchange and connectivity. Examples of the communication network 104 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 104 to incorporate multiple network types and configurations may allow the datacenter 102 to adapt to diverse application needs, from general data communication to specialized HPC tasks. As described herein, the communication network 104 may leverage various optical components to establish communication links (e.g., communicably couple) between components in the architecture 1200. As such, the communication network 104 may include various optical devices, transceivers, modules, and/or the like that are configured to generate optical signals (e.g., provide optical transmitter functionality) and/or receive optical signals (e.g., provide optical receiver functionality).

The network device(s) 1206 may include a variety of computing devices capable of transmitting and receiving signals over the communication network 1204. The network device(s) 1206 may range from personal computing devices to complex server configurations. Examples include Personal Computers (PCs), laptops, tablets, smartphones, and servers. The network device(s) 1206 may facilitate user interactions with the datacenter 1202, allowing for data input, retrieval, and processing from remote locations. In addition to individual computing devices, the network device(s) 1206 may also include collections of servers or additional datacenters. For instance, these could be other datacenters similar to or the same as datacenter 1202. Such an interconnection may allow for the formation of a distributed computing environment for improved redundancy, load balancing, and disaster recovery capabilities. By linking multiple datacenters, the network architecture 1200 may leverage geographically dispersed resources, optimizing performance and ensuring high availability.

As described herein, the datacenter 1202 and/or the network device(s) 1206 may include storage devices and processing circuitry for executing computing tasks, such as controlling the flow of data internally and over the communication network 1204. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the datacenter 1202 and network device(s) 1206 may include one or more communication interfaces for facilitating wired and/or wireless communication between one another and other unillustrated elements of the network architecture 100. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 1200.

Furthermore, the present disclosure contemplates that the network architecture 1200 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 1200 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 1200.

In high-capacity datacenter networks, such as those illustrated in FIGS. 12A-12B, the communication network 1204 may leverage optical transceivers that transmit and receive optical signals over optical fibers or other optical communication mediums in order to establish connection between devices in the architecture 1200.

In at least one example embodiment, the datacenter 1202 corresponds to a collection of network devices, such as network switches (e.g., Ethernet switches, IP routers, multiservice platforms, various transmission network elements, legacy communication equipment, or in any other suitable communication system) connected with a collection of servers or compute nodes. . . .

A switch fabric serves to transfer the data between the switch ports. A switch fabric comprises one or more interconnect circuits, which may be arranged in various switch fabric architectures, e.g., m*m crossbar, Banyan, Benes, Omega, Clos, multi-plane, STS, TST, shared memory, buffered crossbar, any other suitable blocking or non-blocking architecture, or any applicable mixed architecture thereof. A switch fabric is realized in typical embodiments by hardware, which may comprise Field-Programmable Gate Arrays (FPGAs) and/or Application-Specific Integrated Circuits (ASICs), and in some implementations also bus interconnects. The datacenter 1202 may adhere to a networking topology (e.g., a hierarchal networking topology), such as a fat tree topology, a Slim Fly topology, a Dragonfly topology, and/or the like. The datacenter 1202 routes traffic amongst the network switches and servers therein, and at least one layer of the topology in the datacenter 1202 is coupled to the communication network 1204 to allow networking traffic to flow between the datacenter 1202 and the network device(s) 1206.

The communication network 1204 may communicably couple the datacenter 1202 with network device(s) 1206 and other external devices for data exchange and connectivity. Examples of the communication network 1204 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like.

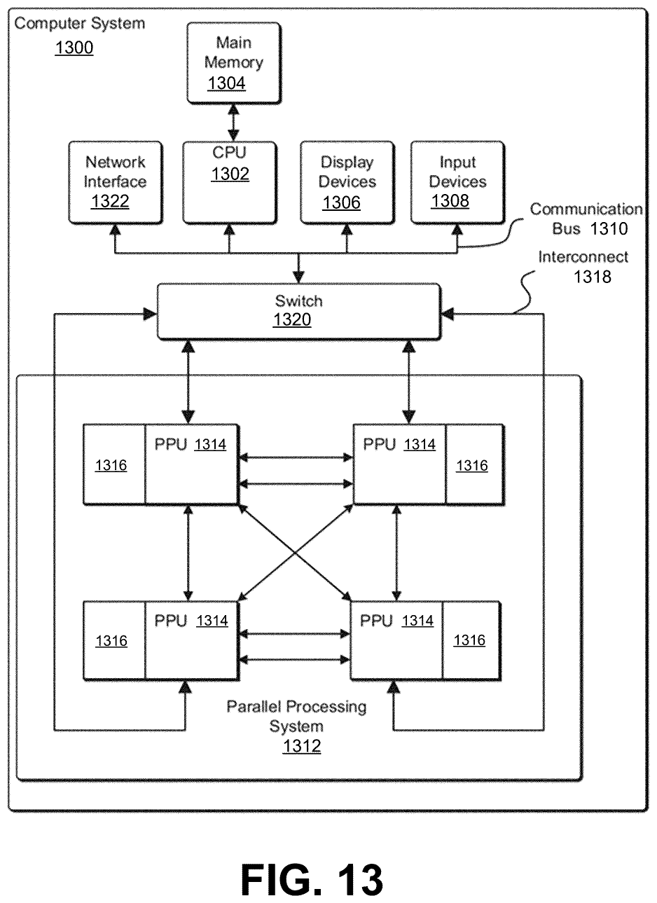

FIG. 13 illustrates a computer system 1300, according to at least one embodiment. In at least one embodiment, computer system 1300 is configured to implement various processes and methods described throughout this disclosure.

In at least one embodiment, computer system 1300 comprises, without limitation, at least one central processing unit (“CPU”) 1302 that is connected to a communication bus 1310 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1300 includes, without limitation, a main memory 1304 and control logic (e.g., implemented as hardware, software, or a combination thereof) and data are stored in main memory 1304 which may take form of random access memory (“RAM”). In at least one embodiment, a network interface subsystem (“network interface”) 1322 provides an interface to other computing devices and networks for receiving data from and transmitting data to other systems from computer system 1300.

In at least one embodiment, computer system 1300, in at least one embodiment, includes, without limitation, input devices 1308, parallel processing system 1312, and display devices 1306 which can be implemented using a conventional cathode ray tube (“CRT”), liquid crystal display (“LCD”), light emitting diode (“LED”), plasma display, or other suitable display technologies. In at least one embodiment, user input is received from input devices 1308 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1304 and/or secondary storage. Computer programs, if executed by one or more processors, enable system 1300 to perform various functions in accordance with at least one embodiment. memory 1304, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1302; parallel processing system 1312; an integrated circuit capable of at least a portion of capabilities of both CPU 1302; parallel processing system 1312; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1300 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1312 includes, without limitation, a plurality of parallel processing units (“PPUs”) 1314 and associated memories 1316. In at least one embodiment, PPUs 1314 are connected to a host processor or other peripheral devices via an interconnect 1318 and a switch 1320 or multiplexer. In at least one embodiment, parallel processing system 1312 distributes computational tasks across PPUs 1314 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1314, although such shared memory may incur performance penalties relative to use of local memory and registers resident to a PPU 1314. In at least one embodiment, operation of PPUs 1314 is synchronized through use of a command such as_syncthreads( ), wherein all threads in a block (e.g., executed across multiple PPUs 1314) to reach a certain point of execution of code before proceeding.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code, while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “identifying,” “causing,” “adjusting,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” or “processing logic” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A fiber array unit comprising:
a substrate;
a first set of one or more fibers disposed in the substrate, the first set of one or more fibers to transmit an emitted light from a light source to a destination component;
a second set of one or more fibers disposed in the substrate and arranged in a parallel orientation relative to the first set of one or more fibers, the second set of one or more fibers to:
transmit the emitted light from the light source to the destination component, and
transmit at least a portion of returned light received from a deflective surface of the destination component; and
a refractive component disposed in optical communication with the second set of one or more fibers, wherein the refractive component folds at least a portion of the emitted light in a perpendicular orientation relative to the deflective surface of the destination component.

2. The fiber array unit of claim 1, wherein the refractive component comprises a material having a same refractive index as the second set of one or more fibers.

3. The fiber array unit of claim 1, wherein the returned light is transmitted by the second set of one or more fibers to an optical power meter.

4. The fiber array unit of claim 1, wherein the second set of one or more fibers comprises at least one collimating fiber.

5. The fiber array unit of claim 1, wherein the second set of one or more fibers comprises at least one non-collimating fiber.

6. A system comprising:
a fiber array unit coupled to a light source, the fiber array unit comprising:
a first set of one or more fibers to transmit an emitted light from the light source to a destination component;
a second set of one or more fibers arranged in a parallel orientation relative to the first set of one or more fibers, the second set of one or more fibers to:
transmit the emitted light from the light source to the destination component, and
transmit at least a portion of a first returned light received from a deflective surface of the destination component; and
a refractive component disposed in optical communication with the second set of one or more fibers, wherein the refractive component folds at least a portion of the emitted light in a perpendicular orientation relative to the deflective surface of the destination component;
an optical power meter to:
receive the at least the portion of the first returned light from the second set of one or more fibers; and
measure a first power level of the first returned light; and
a control system coupled to the optical power meter, the control system to adjust, based on the first power level, one or more tilt angles associated with the fiber array unit relative to the destination component.

7. The system of claim 6, wherein the control system compares the first power level of the first returned light to a threshold level.

8. The system of claim 7, wherein the control system determines that the first power level of the first returned light is less than the threshold level.

9. The system of claim 8, wherein the one or more tilt angles of the fiber array unit are increased or decreased by a step amount.

10. The system of claim 7, wherein the fiber array unit having an adjusted set of one or more tilt angles relative to the destination component transmits at least a portion of a second returned light received from a deflective surface of the destination component.

11. The system of claim 10, wherein the optical power meter receives the at least the portion of the second returned light from the second set of one or more fibers of the fiber array unit having the adjusted set of one or more tilt angles; and measures a second power level of the second returned light.

12. The system of claim 11, wherein the control system compares the second power level of the second returned light to the threshold level.

13. The system of claim 12, wherein the control system determines that the second power level of the second returned light is greater than or equal to the threshold level indicating that the fiber array unit having the adjusted set of one or more tilt angles are in a target alignment with the destination component.

14. The system of claim 6, wherein the control system adjusts a gap distance between the fiber array unit and the destination component.

15. A method comprising:
causing emitted light to be transmitted from a light source to a destination component via a fiber array unit including a first set of fibers and one or more alignment fibers;
identifying a first power level of a first returned light level received from the destination component via the one or more alignment fibers;
determining, by a processing device of a control system, the first power level is less than a threshold level;
identifying a first tilt angle of a set of tilt angles of the fiber array unit relative to the destination component; and
adjusting the first tilt angle of the first set of tilt angles.

16. The method of claim 15, further comprising:
identifying a second power level of a second returned light level received from the destination component via the one or more alignment fibers of the fiber array unit having an adjusted first tilt angle.

17. The method of claim 16, further comprising:
determining the second power level is greater than or equal to the threshold level indicating that the fiber array unit having the adjusted first tilt angle and an adjusted second tilt angle are in a target alignment with the destination component.

18. The method of claim 16, further comprising:
determining the second power level is less than the threshold level;
identifying a second tilt angle of the set of tilt angles of the fiber array unit relative to the destination component; and
adjusting the second tilt angle of the first set of tilt angles.

19. The method of claim 18, further comprising:
identifying a third power level of a third returned light level received from the destination component via the one or more alignment fibers of the fiber array unit having the adjusted first tilt angle and an adjusted second tilt angle; and
determining the third power level is less than the threshold level.

20. The method of claim 19, further comprising:
identifying a gap distance between the destination component and the fiber array unit having the adjusted first tilt angle and the adjusted second tilt angle; and
adjusting the gap distance.
